(19) United States
(12) Patent Application Publication
(10) Pub. No.: US 2013/0126686 A1
(43) Pub. Date: May 23, 2013

(54) LUGGAGE CUP HOLDER

(71) Applicant: DAVID BALLOU, Fort Lauderdale, FL (US)

(72) Inventor: DAVID BALLOU, Fort Lauderdale, FL (US)

(21) Appl. No.: 13/299,742

(22) Filed: Nov. 18, 2011

(51) Int. Cl. F16M 13/02; A44B 18/00

(52) U.S. Cl. 248/205.2; 248/220.22

(57) ABSTRACT

A luggage cup holder that is easy to install and remove from a luggage handle. The luggage cup holder includes a first hood-shaped section adapted to encase a hand grip of a luggage handle, a second section adapted to hold a beverage container, straps connecting the first section to the second section; and a connecting system to connect the first side to the second side of the second section forming a hollow cylinder. The connecting system is configured to adjust the size of the hollow cylinder. The luggage cup holder is made of a synthetic rubber or polymeric foam material.

### BACKGROUND OF THE INVENTION

The present invention generally relates to a cup holder. More particularly, the present invention relates to a luggage cup holder adapted to be attached to the handle of luggage.

Travelers are frequently seen walking through an airport or other location wheeling carry-on luggage with one hand, and personal items or a beverage drink container in the other hand. This situation becomes cumbersome when the use of the other hand is required to do simple tasks such as open doors or searching for traveling documents. The prior art shows devices that facilitate the hands-free carrying of a beverage drink container in conjunction with a luggage handle. Unfortunately, the known devices are permanently attached to the handle, are difficult to install and remove from the handle, or are not adjustable. Furthermore, the known devices might impair the telescopic function of the handle.

As can be seen, there is a need for a beverage container holder for luggage that is easy to install and remove from the luggage handle.

### SUMMARY OF THE INVENTION

In one aspect of the present invention, a luggage cup holder includes a first hood-shaped section adapted to encase a hand grip of a luggage handle, a second section adapted to hold a beverage container, straps connecting the first section to the second section; and a connecting system to connect the first side to the second side of the second section forming a hollow cylinder, the connecting system is configured to adjust the size of the hollow cylinder, and the luggage cup holder is made of a synthetic rubber or polymeric foam material.

In another aspect of the present invention, a luggage cup holder including a first hood-shaped section adapted to encase a hand grip of a luggage handle; a second section adapted to hold a beverage container; straps connecting the first section to the second section; a connecting system to connect the first side to the second side of the second section forming a hollow cylinder, the connecting system includes a first interconnecting section secured to the first side of the second section and a second interconnecting section secured to the second side of the second section; a bottom strap secured to the bottom end of the second section; the connecting system is configured to adjust the size of the hollow cylinder; and the luggage cup holder is made of a synthetic rubber or polymeric foam material.

These and other features, aspects and advantages of the present invention will become better understood with reference to the following drawings, description and claims.

### BRIEF DESCRIPTION OF THE DRAWINGS

FIG. 1 is a side view of a luggage cup holder according to an exemplary embodiment of the present invention showing the luggage cup holder in use;

FIG. 2 is a front view of the luggage cup holder of FIG. 1;

FIG. 3 is a top view of the luggage cup holder as indicated by line 3-3 of FIG. 1;

FIG. 4 is a side view of a luggage cup holder for luggage according to another exemplary embodiment of the present invention showing the luggage cup holder in use;

FIG. 5 is a front view of the luggage cup holder of FIG. 4;

FIG. 6A is a front view of the cup holder, open-faced of FIG. 1;

FIG. 6B is a front view of a bottom strap of the luggage cup holder of FIG. 4;

FIG. 7 is a front view of a cup holder, open faced according to another exemplary embodiment of the present invention; and

FIG. 8 is a detailed view of a connecting system for the luggage cup holder of FIG. 1 showing the connecting system being a loop and lace fastener.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a cup holder for luggage that is easy to install and remove from a luggage handle.

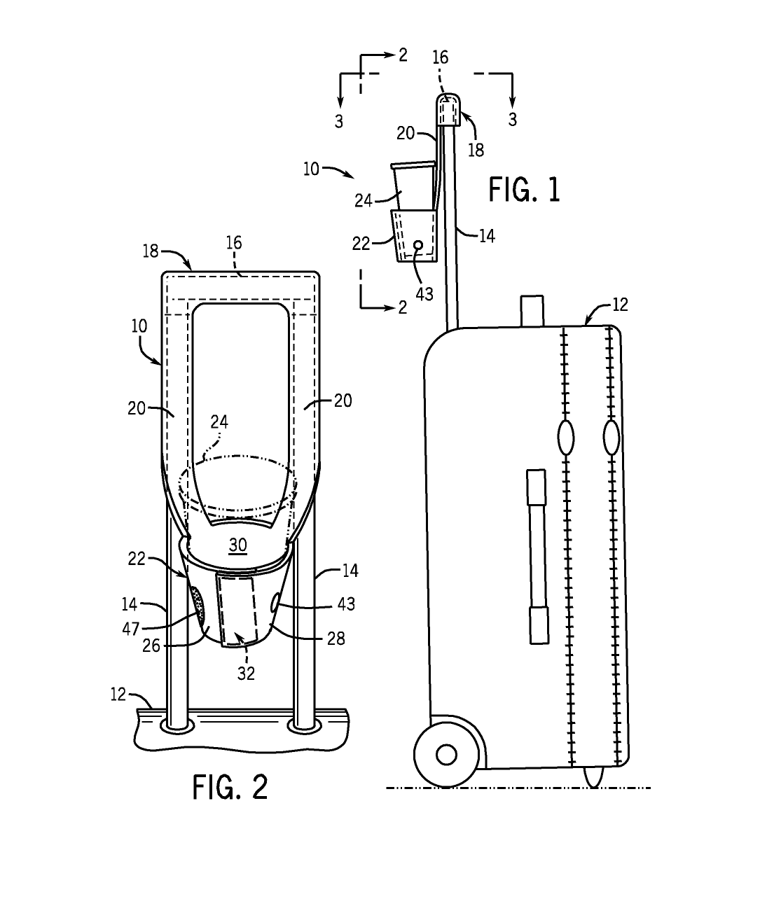

FIGS. 1-3 and 6A show a cup holder 10 for a luggage 12 according to an exemplary embodiment of the present invention. The cup holder 10 may be attached to a hand grip 16 of a handle 14 of the luggage 12. The cup holder 10 may allow the user (not shown) to carry a beverage container 24 while walking through an airport or other location wheeling the luggage 12.

The cup holder 10 may include a first section 18, a second section 21, and straps 20 connecting the first section 18 to the second section 21. The cup holder 10 may be a unitary piece body. The cup holder 10 may be made of a synthetic rubber or polymeric foam material. In some embodiments, the synthetic rubber or polymeric foam material may be, for example, polychloroprene, commonly referred to as neoprene. The synthetic rubber or polymeric foam material may provide the cup holder 10 with insulation capabilities to help maintain the temperature of the drink. In addition, the synthetic rubber or polymeric foam material may help in retaining the shape of the cup holder 10 to facilitate the insertion and removal of the beverage cup 24. Furthermore, the synthetic rubber or polymeric foam material may provide the cup holder 10 with the strength necessary to hold the beverage cup 24. Finally, the synthetic rubber or polymeric foam material may provide the cup holder 10 with a gripping surface that may not slip from the handgrip 16 of the luggage 12.

The synthetic rubber or polymeric foam material may be fabric coated neoprene. The fabric coated neoprene may provide the cup holder 10 with a smooth surface. The smooth surface may reduce friction caused by inserting and removing the beverage container 24 from the cup holder 10.

The thickness of the synthetic rubber or polymeric foam material may be between 4 and 6 mm for shape retention and strength.

As can be seen in FIGS. 1-3, the first section 18 may be adapted to encase the hand grip 16 of the handle 14. The first section 18 may have the shape of a hood, a cap, or a sleeve. The flexibility of the synthetic rubber or polymeric foam material may allow the first section 18 to securely stay on the hand grip 16. In addition, the flexibility of the synthetic rubber or polymeric foam material may allow the first section 18 to be encased in different sized and shaped hand grips 16.

The straps 20 may hold the first section 18 and second section 21 together. The straps 20 may rest along the handle 14. The size of the straps 20 may depend on the style of the luggage 12.

As can be seen in FIGS. 2-3 and 6A, the second section 21 may be adapted to hold the beverage container 24. The second section 21 may include a first side 26, a second side 28, and connecting system 32 to connect the first side 26 to the second side 28. The second section 21 may take the form of a hollow cylinder when the first side 26 is connected to the second side 28. The connecting system 32 may help the user (not shown) to adjust the size of the second section 21 in order to accept different sizes of beverage containers 24.

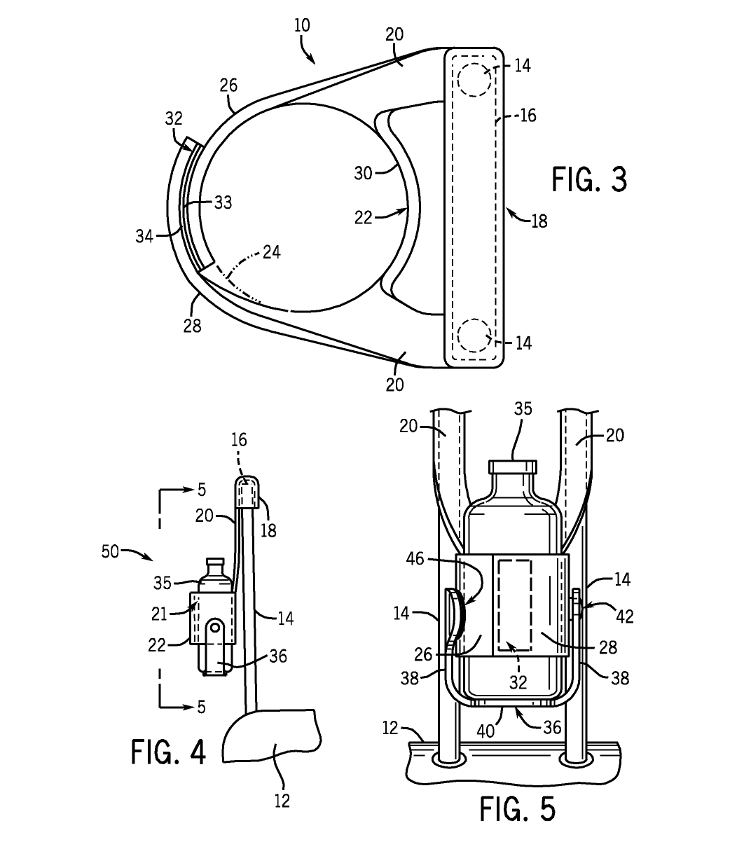

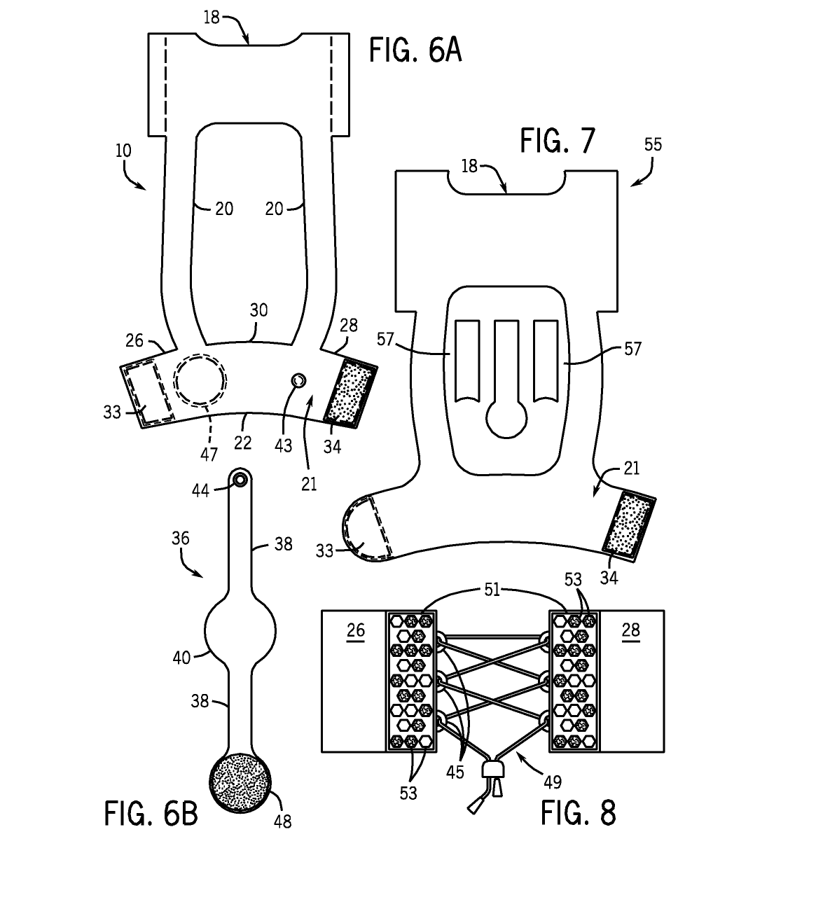

As can be seen in FIGS. 3 and 6A, the connecting system 32 may include a first interconnecting section 33 and a second interconnecting section 34. The first interconnecting section 33 may be secured to the first side 26 of the second section 21. The second interconnecting section 34 may be secured to the second side 28 of the second section 21. In one exemplary embodiment, the first side 26 and the second side 28 may be fabric straps made from the same material as the straps 20 connected to one another using a hook 33 and loop 34 system. While the connecting system 32 is described in the context of a hook and loop fastener, it will be understood that other fasteners, for example, male and female connectors, zippers, clasps, snaps, clamps, buckles, press studs, or buttons and buttonhole fasteners, can be used.

The user (not shown) may encase the handgrip 16 of the handle 14 by stretching the first section 18 over the hand grip 16. The user may adjust the size of the second section 21 to fit the size of the beverage container 24 to be used. The straps 20 may be placed resting over the handle 14 facing the intended direction of travel. The interconnecting system 35 may also be placed facing the direction of travel to facilitate installing and removing the beverage container 24 from the cup holder 10.

As can be seen in FIG. 8 the connecting system 32 may, in another exemplary embodiment, include a plurality of loops 45 and a lace 49 to secure the first side 26 to the second side 28. The lace 49 may be an elastic cord to allow adjusting the size of the second section 21 and maintain a firm grip on the beverage container 24. In some embodiments, decorative panels 51 may be secured to the first side 26 and the second side 28. The decorative panels 51 may include ornaments 53, for example, gems, stones, pearls, glitter, holiday motifs, logos, images, designs, or patterns.

FIG. 6A shows that the second section 21 may include a top end 30, a bottom end 22, a first side 26, and a second side 28. The second section 21 may have the shape of an arched rectangle. When connecting the first side 26 and the second side 28, the arched rectangle may form the hollow cylinder having walls tapering from the top end 30 towards the bottom end 22. The tapering walls may allow the beverage container 24 to fit in the second section 21 up to a maximum circumference thus preventing the container from falling through the second section 21 (FIG. 2).

FIGS. 4-5 and 6B show a luggage cup holder 50 for the luggage 12 according to another exemplary embodiment of the present invention. The cup holder 50 may be similar to the cup holder 10 except that, the cup holder 50 may include a bottom strap 36 connected to the second section 21. The bottom strap 36 may help in retaining a small container 35 from falling out of the cup holder 50.

FIG. 6B shows that the bottom strap 36 may include a middle section 40 and sides 38. The middle section 40 may have a shape that helps in retaining the small container 35, for example, round, square, or rectangular. A first connecting piece 44 may be secured to one of the sides 38. A second connecting piece 48 may be secured to the other side 38.

As can be seen in FIG. 5, the first connecting piece 44 of the bottom strap 36 may be interconnected to a first fastener 43 on the second section 21 forming a first connecting point 42. The second connecting piece 48 of the bottom strap 36 may be interconnected to a second fastener 47 on the second section 21 forming a second connecting point 46.

The cup holder 10;50 may allow the user to hold the beverage container 24 or small container 35 in a level condition, preventing spillage of the drink.

FIG. 7 shows a luggage cup holder 55 according to another exemplary embodiment of the present invention. The cup holder 55 may be the same as the embodiment shown in FIG. 1 except that the cup holder 55 may include a plurality of integrated side straps 57 attached second section 21 to the to prevent the beverage container 24 from falling out of the cup holder 55. The second section 21 may take the form of a hollow cylinder when the first interconnecting section 33 and a second interconnecting section 34. are secure to each other. The side straps 57 may be distribute around the bottom end of the second section 21 wrapping the bottom of the beverage container 24.

It should be understood, of course, that the foregoing relates to exemplary embodiments of the invention and that modifications may be made without departing from the spirit and scope of the invention as set forth in the following claims.

What is claimed is:

1. A luggage cup holder comprising:
a first hood-shaped section adapted to encase a hand grip of a luggage handle;
a second section adapted to hold a beverage container, the second section including a top end, a bottom end, a first side, and a second side;
straps connecting the first section to the second section; and
a connecting system to connect the first side to the second side of the second section forming a hollow cylinder, the connecting system configured to adjust the size of the hollow cylinder, wherein
the luggage cup holder is made of a synthetic rubber or polymeric foam material.

2. The luggage cup holder according to claim 1, wherein the luggage cup holder is a unitary piece body.

3. The luggage cup holder according to claim 1, wherein the synthetic rubber or polymeric foam material is neoprene.

4. The cup holder according to claim 1, wherein the synthetic rubber or polymeric foam material is fabric coated neoprene.

5. The luggage cup holder according to claim 1, wherein the second section has a shape of an arched rectangle.

6. A luggage cup holder comprising:
a first hood-shaped section adapted to encase a hand grip of a luggage handle;
a second section adapted to hold a beverage container, the second section including a top end, a bottom end, a first side, and a second side;
straps connecting the first section to the second section;
a connecting system to connect the first side to the second side of the second section forming a hollow cylinder, the connecting system includes a first interconnecting section secured to the first side of the second section and a second interconnecting section secured to the second side of the second section; and
at least one strap secured to the bottom end of the second section;
the connecting system is configured to adjust the size of the hollow cylinder, and
the luggage cup holder is made of a synthetic rubber or polymeric foam material.

7. The luggage cup holder according to claim 6, wherein the connecting system includes hook and loop fasteners, male and female connectors, zippers, clasps, snaps, clamps, buckles, press studs, or buttons and buttonhole fasteners.

8. The luggage cup holder according to claim 6, wherein the cup holder is a unitary piece body.

9. The luggage cup holder according to claim 6, wherein the synthetic rubber or polymeric foam material is neoprene.

10. The luggage cup holder according to claim 6, wherein the synthetic rubber or polymeric foam material is fabric coated neoprene.
